(19) United States
(12) Patent Application Publication
(10) Pub. No.: US 2025/0196019 A1
(43) Pub. Date: Jun. 19, 2025

(54) VESSEL-FILLING ILLUSION

(71) Applicant: Universal City Studios LLC, Universal City, CA (US)

(72) Inventors: Timothy Fitzgerald Garnier, Orlando, FL (US); Akiva Meir Krauthamer, Orlando, FL (US)

(21) Appl. No.: 18/978,666

(22) Filed: Dec. 12, 2024

Related U.S. Application Data
(60) Provisional application No. 63/610,572, filed on Dec. 15, 2023.

(51) Int. Cl. A63J 21/00; B67D 1/00; B67D 1/08

(52) U.S. Cl. CPC A63J 21/00; B67D 1/0042; B67D 1/0872; B67D 2001/0095

(57) ABSTRACT

A show effects system includes a beverage filler system, a special effects system and a control system. The beverage filler system includes a base that supports a vessel and a beverage controller used to control a flow of a beverage into the vessel. The special effects system includes one or more displays used to display an image and a semi-reflective mirror including a first side and a second side and positioned between the one or more displays and the vessel. Further, the semi-reflective mirror permits viewing of the display, transmitted through the first side, at the second side and viewing of a reflection of an environment of the vessel at the second side. The control system includes a processor that receives a signal indicative of a presence of the vessel on the base and activates at least the special effects system or the beverage filler system based on the signal.

### CROSS-REFERENCE TO RELATED APPLICATION

This application claims priority from and the benefit of U.S. Provisional Application Ser. No. 63/610,572, entitled “VESSEL-FILLING ILLUSION”, filed Dec. 15, 2023, which is hereby incorporated by reference in its entirety.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The subject matter disclosed herein relates to the field of interactive and visual guest experiences. More specifically, embodiments of the present disclosure relate to systems and methods for generating special effects on or near food and beverage vessels.

Various amusement rides, exhibits, and demonstrations have been created to provide guests with unique interactive, motion, and visual experiences. Such experiences may be designed to provide enhancement to everyday activities to create a fantastical environment. In various rides and exhibits, guest experiences may be enhanced by employing certain interactive visual features within the rides and exhibits. However, some interactive visual features may be costly and ill-suited for incorporation into personalized interactions that guests may directly watch, touch, smell, and taste.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a show effects system includes a beverage filler system, a special effects system and a control system. The beverage filler system includes a base that supports a vessel and a beverage controller used to control a flow of a beverage into the vessel. The special effects system includes one or more displays used to display an image and a semi-reflective mirror including a first side and a second side and positioned between the one or more displays and the vessel. Further, the semi-reflective mirror permits viewing of the display, transmitted through the first side, at the second side and viewing of a reflection of an environment of the vessel at the second side. The control system includes a processor that receives a signal indicative of a presence of the vessel on the base and activates at least the special effects system or the beverage filler system based on the signal.

In an embodiment, a method includes receiving a signal indicative of a presence of a vessel on a base and activating, via a control system, at least a special effects system or a beverage filler system based on the signal. The method also includes displaying an image, via one or more displays and generating a special effect on or near the vessel. Further, the method includes controlling the beverage filler system to cause a beverage controller to activate a flow of beverage into the vessel.

In an embodiment, a show effects system includes a special effects system and a control system. The special effects system includes a controller, one or more displays configured to display an image, and a semi-reflective mirror comprising a first side and a second side. The semi-reflective mirror is positioned between the one or more displays and a vessel and permits viewing of the display, transmitted through the first side, at the second side and viewing of a reflection of an environment of the vessel at the second side. The special effects system also includes one or more props configured to actuate. The control system includes a processor that receives a signal indicative of a presence of the vessel on a base and activates the special effects system based on the signal. Further, the special effects system causes the one or more displays to display the image and the one or more props to actuate. The control system also activates a beverage filler system wherein activating the beverage filler system causes a beverage controller to activate a flow of beverage into the vessel.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of a food and beverage venue that includes a show effects system, in accordance with embodiments described herein;

FIG. 2 is a block diagram of a show effects system, in accordance with embodiments described herein;

FIG. 3 is a schematic illustration of a side view of the show effects system, in accordance with embodiments described herein;

FIG. 4 is a schematic illustration of a top view of the show effects system, in accordance with embodiments described herein;

FIG. 5 is a schematic illustration of a vessel interacting with the show effects system, in accordance with embodiments described herein; and

FIG. 6 is a flow diagram of a method to control a refreshments special effects system, in accordance with embodiments described herein.

### DETAILED DESCRIPTION

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

It is now recognized that food and beverage venues in amusement parks may lack interactive components that may provide guests with enjoyment. For example, staff members of food and beverage venues may prepare themed refreshments (e.g., food, beverages, drinks, alcoholic beverages) for guests. However, certain types of food and beverage effects may be more immersive if the effect includes interactions from characters associated with themed elements. As such, characters may take part in a cooking or mixing experience (e.g., potions, secret recipes, magic spells) during creation of themed refreshments. Inclusion of effects (e.g., including characters) as part of a food and beverage preparation experience may be challenging. For example, incorporating displayed or projected media without obstructing the view of the observer may be difficult. Realistic effects including projection of characters may be challenging to achieve without inclusion of various housings and other assemblies that may block views of guests.

Provided herein is a show effects system that facilitates generating visual illusions of pouring or preparing beverages in or near one or more vessels (e.g., glassware or containers) in conjunction with a beverage filler system that provides a physical beverage to the vessels. The show effects system may create visual effects (e.g., Pepper's Ghost effect, projected or displayed effects) to enhance guest experiences, create enjoyment, or enhance a narrative part of an immersive environment. The disclosed embodiments may incorporate a special effect arrangement aligned with the beverage filler such that the illusion is not perceptible to an observer. For example, a semi-reflective mirror positioned between the observer and an image display/projector can permit viewing of imagery through the mirror while the mirror also reflects the environment. Based on the relative positions of the beverage filler, the mirror, and the generated imagery, the image generated on the mirror may include both reflected and generated components. These reflected and generated components can align in the mirror to produce the illusion. For example, imagery of a food or beverage preparer (e.g., a bartender) not physically positioned behind a bar may appear in the mirror creating illusions that the food or beverage preparer is filling beverages while physical vessels are filled with liquids (e.g., beer, juice, etc.). The show effects system may permit viewable preparation of refreshments (e.g., food and/or beverage) by the food or beverage preparer in front of guests for guest enjoyment while simultaneously fulfilling refreshment orders placed by guests. As such, visual effects are generated in reflections on or near vessels (e.g., glasses, food items) using mirrors to generate realistic portrayal of special effects on or near vessels viewable by the guests while systems such as the beverage filler system is used to fill the vessel with liquid. In one example, a special effect may include illusions of a character operating as a food or beverage preparer (e.g., a monster, an animal, an alien, real-world celebrity, a ghost, an inanimate object) and pouring liquids (e.g., drinks, potions, cheese, soup, condiments, gravy, etc.) into the vessel. In an embodiment, show effects system may match timing of illusions displayed on the vessel with liquids being added by the beverage filler system to generate illusion-enhanced experiences of food and beverage preparation to enhance guest experiences.

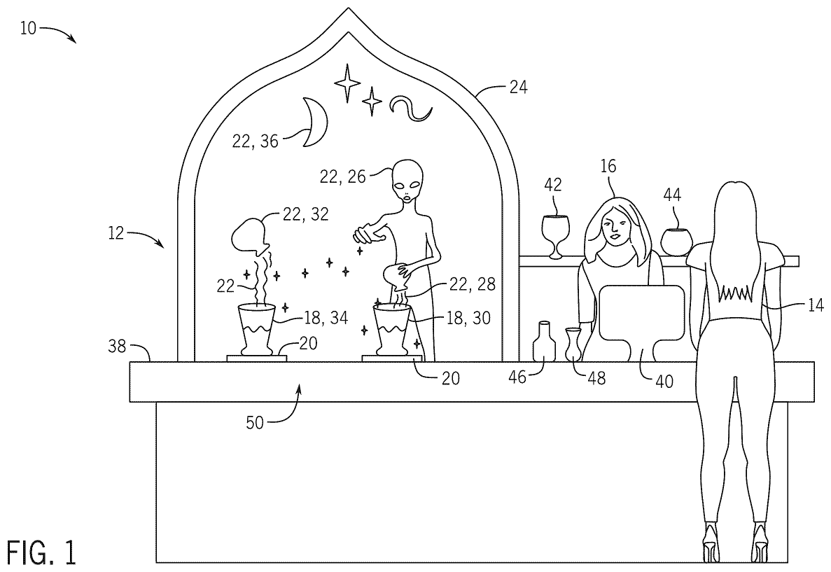

Procedures, in accordance with the present disclosure (applicable to procedures illustrated in FIGS. 1-6) for producing food and beverage effects may include various different steps and procedural aspects. Some of these steps or procedures may be performed in parallel or in varying different orders. Some steps may be processor-based operations and may involve controlled equipment (e.g., actuators or sensors). Accordingly, while various different procedural steps may be discussed in a particular order herein, the procedural steps may not necessarily be performed in the order of introduction, as set forth by the present disclosure. While some specific steps of an operation may necessarily occur before other specific steps (e.g., as dictated by logic), the listing of certain orders of operation are primarily provided to facilitate discussion. For example, indicating that a first step or a beginning step includes a particular operation is not intended to limit the scope of the disclosure to such initial steps. Rather, it should be understood that additional steps may be performed, certain steps may be omitted, referenced steps may be performed in an alternative order or in parallel where appropriate, and so forth. However, disclosed orders of operation may be limiting when indicated as such.

FIG. 1 is a schematic illustration of an environment 10. It should be understood that the environment 10 is by way of example, and other contexts for use in conjunction with the show effects system are also contemplated. The environment 10 may be part of an amusement park or other narrative experience that facilitates guest interaction through the inclusion of visual experiences. The environment 10 may be any restaurant, bar, food and beverage, or other entertainment venue. The environment 10 may be part of a retail experience, an attraction experience, an educational experience, a tourism experience, etc. The environment 10 includes one or more show effects systems 12 that may be used to generate a visual effect (e.g., visual food effect and/or visual beverage effect).

In the illustrated example, an observer 14 (e.g., a guest) may order, purchase, and/or receive refreshments from a staff member 16. As such, the staff member 16 may prepare a refreshment (e.g., using a vessel 18 as an empty or available beverage and/or food container) in conjunction with the show effects system 12. The show effects system 12 may include a control system, a beverage filler system and/or a special effects system. As such, the control system may activate the beverage filler system when the vessel 18 is positioned on a base 20 to fill the vessel 18 with a beverage. Additionally, the control system may transmit a signal to the special effect system to generate special effects 22 (e.g., one or more special effects, one or more illusions, visual effect, imagery projection, Pepper's Ghost effect) on or near the vessel 18.

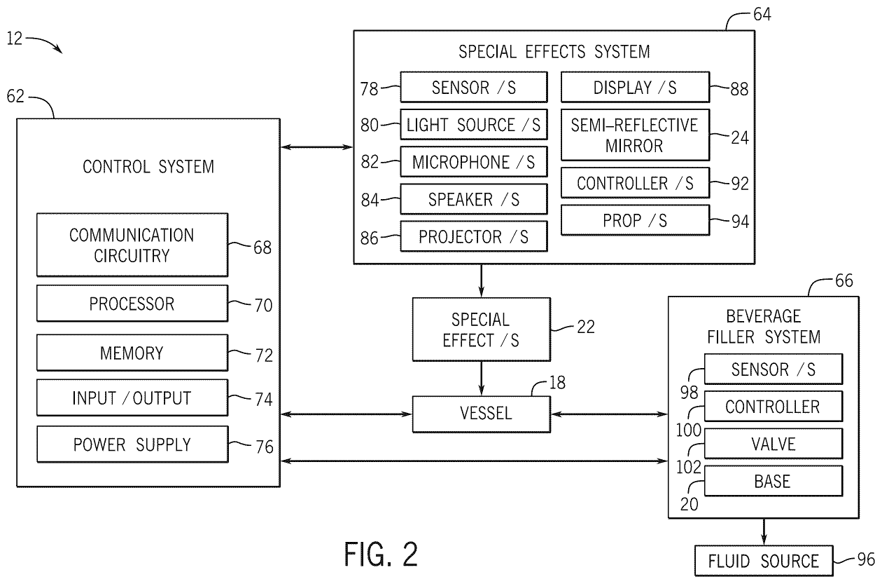

In some embodiments, the special effects 22 may be generated by a display (see FIG. 2) positioned behind (e.g., on a first side) a semi-reflective mirror 24. The special effects 22 may be generated and appear as reflections operating on or positioned near the vessel 18 (e.g., glasses, food items). As such, the display generates imagery on the first side of the semi-reflective mirror 24 allowing the special effects 22 to appear on a second side of the semi-reflective mirror 24 as images viewable by the observer 14. In some cases, the special effects 22 may include various illusions including a food or beverage preparer 26 (e.g., an illusory bartender). The food or beverage preparer 26 may appear to be pouring a potion 22, 28 (e.g., from a fantastic source) into the vessel 18, 30 generating illusions viewable by the observer 14. It should be noted that the food or beverage preparer is one non-limiting example, the various illusions may include a scientist, an alchemist, a gardener, a blacksmith, a real-world celebrity, a barista, a mixologist, and the like. As such, illusions may be created such as mixing a reaction, mixing an elixir, watering a potted plant, pouring molten metal, pouring coffee, etc.). In some instances, the special effects 22 may include a bottle 22, 32 that may appear to be pouring liquid into a vessel 18, 34 from mid-air (e.g., without the presence of the staff member 16). That is, the food or beverage preparer illusion may be an illusion of self-pouring drinks. In some embodiments, additional special effects 22, 36 may be generated by the display and appear in the semi-reflective mirror 24 as reflections surrounding the vessel 18 to add to fantastic illusions. The special effects 22 may enhance the immersive experience of the observer 14 within the environment 10 of the food and beverage venue.

With the foregoing in mind, in some embodiments, the show effects system 12 may include components that enhance the illusion, such as light sources (e.g., one or more light sources), speakers (e.g., one or more speakers), microphones (e.g., one or more microphones), projectors (e.g., one or more projectors), displays (e.g., one or more displays), and sensors (e.g., one or more sensors) used to detect the vessel 18, activate the special effects system, and activate the beverage filler system. The beverage filler system may be positioned on a surface 38 (e.g., bar, table, cart, stand). For example, the observer 14 may order the refreshment from the staff member 16 at the point of sale terminal 40. The staff member 16 may select the vessel 18 associated with the refreshment ordered by the observer 14. The observer 14 may order refreshments associated with different cups or glasses 42, 44, 46, 48 of the illustrated embodiment. It is to be noted, that the glasses 42, 44, 46, 48 serve by way of example and additional or other beverage and/or food container shapes may be used show effects system 12.

Further, in general operation, the staff member 16 may select the vessel 18 (illustrated as glass 30) associated with the refreshment ordered by the observer 14. The glass 30 may then be supported by the base 20 within a viewing area 50 of the show effects system 12. The show effects system 12 may activate the special effects system and/or the beverage filler system when the vessel 18 is detected on the base 20 and/or within the viewing area 50. The special effects system may generate the special effects 22 (e.g., display visual effects to be viewed through the semi-reflective mirror 24). In some instances, it may be advantageous for the staff member 16 to leave the viewing area 50 during the activation of the special effects system and/or the beverage filler station in order to ensure reflections and images in the semi-reflective mirror 24 (e.g., reflections in the semi-reflective mirror 24) are not distorted. As such, the viewing area 50 may be free from obstructed views allowing the observer 14 to experience realistic special effects during fantastical pouring and/or mixing of the ordered beverage.

In some embodiments, the image displayed by the one or more displays may be prerecorded. As such, the special effects system 64 may cause the display to display the prerecorded images that may be initiated based on a particular selected refreshment. In some instances, the images may be generated in real time to produce effects based on inputs from the staff member 16. The special effects 22 generated from the special effects system 64 may be dynamic or variable based on the observer 14 and/or events happening in the environment 10. For example, the food or beverage preparer 26 may be controlled by the special effects system 64 to appear to react to events in the environment 10 such as greeting guests as they enter, changes in lighting, or other things of the like. In this manner, the food or beverage preparer 26 may pause pouring and appear to the observer 14 to be reacting to real world events.

With the foregoing in mind, in some embodiments, generation of one or more illusions by the special effects system of the show effects system 12 may provide more immersive environments, because the beverage filler system may be activated to fill the vessel 18 with liquid in parallel with generation of the special effects 22. As such, the control system may activate the beverage filler system may include a valve disposed on a bottom of the vessel 18 positioned on the base 20. The valve may be used to allow flow of the beverage into the vessel 18 from the bottom of the vessel 18 in absence of interaction by the staff member 16 (e.g., liquid flow from the base 20 into the vessel 18).

In certain embodiments, the special effects system may generate instructions to activate the special effects 22 and/or the additional special effects that may include auxiliary audio and visual effects. In some cases, a sound may be played over the speakers that adds to the illusion displayed in the semi-reflective mirror 24. In one example, a potion is poured by the food or beverage preparer 26 while the sound (e.g., illusory bartender voice, musical cues, etc.) is played to match the special effects 22 surrounding the vessel 18. In another example, a shadow of the ill food or beverage preparer's arm is projected on the surface 38 (e.g., bar) to appear as if the food or beverage preparer 26 is present within the viewing area 50. The special effects 22 (e.g., illusions) generated on or near the vessel 18 may be activated in any suitable order to create dynamic illusions to enhance immersive experiences viewed by the observer 14.

FIG. 2 is a block diagram of the show effects system 12 that may be implemented to generate special effects 22 on or near a vessel 18 and/or fill the vessel 18 with a beverage in an environment of the present embodiment. The show effects system 12 may include a control system 62, a special effects system 64 and a beverage filler system 66. The control system 62 may communication circuitry 68, a processor 70, a memory 72, an input/output (I/O) port 74, a power supply 76 (e.g., wired power, a battery) and the like. The control system 62 may activate the special effects system 64 and/or the beverage filler system 66. It should be noted, that the beverage filler system 66 is one non-limiting example of a filler system and one or more additional non-beverages may be dispensed from the filler system. For example, the filler system may dispense cheese, condiments, gravy, and the like.

The communication circuitry 68 may facilitate wired or wireless communication between various components of the control system 62 as well as with external devices, such as the point of sale terminal 40 shown in FIG. 1, one or more radio frequency identification (RFID) tag(s) positioned on or near the vessel 18, or central or local controllers of the amusement park or immersive experience. The processor 70 may be any suitable type of computer processor or microprocessor capable of executing computer-executable code. Moreover, the processor 70 may include multiple microprocessors, one or more “general-purpose” microprocessors, one or more special-purpose microprocessors, and/or one or more application specific integrated circuits (ASICS), or some combination thereof. For example, the processor 70 may include one or more than one reduced instruction set (RISC) or complex instruction set (CISC) processors. In some embodiments, the processor 70 may receive inputs transmitted from, as shown in FIG. 1, the point of sale terminal 40 may be positioned on the surface 38 (e.g., bar) and communicate with the special effects system and/or the beverage filler system using the communication circuitry 68. For example, as shown in FIG. 1, the staff member 16 may position the vessel 18 on the base 20 prior to the observer 14 entering the environment 10. As such, the control system 62 may receive a signal indicating that the vessel 18 is located on the base 20. In some instances, the control system 62 may control the special effect system 64 to activate the special effects 22 based on a sale made at the point of sale terminal 40. The show effects system 12 may activate the beverage filler system and the special effects system based on the sale and fill the vessel 18 located on the base 20 (e.g., prior to sale by the staff member 16) while displaying special effects 22 to create visual effects in absence of the staff member 16 illustrated in FIG. 1 with the show effects system 12.

The memory 72 of the control system 62 may also be used to store the data, various other software applications, and the like that are executed by the processor 70. The memory 72 may represent non-transitory computer-readable media (e.g., any suitable form of memory or storage) that may store the processor-executable code used by the processor 60 to perform various techniques described herein. The I/O ports 74 may be interfaces that may couple to other peripheral components such as input devices (e.g., keyboard, mouse), sensors, input/output (I/O) modules, and the like. The power supply 76 may provide power to one or more components of the control system 62. The components of the control system 62, the special effects system 64, and/or the beverage filler system 66 may be integrated within the food and restaurant venue including in the point of sale terminal 40, the surface 38, or any other suitable component of the show effects system 12. As such, the control system 62 may be concealed at least in part from view of an observer.

The control system 62 of FIG. 2 may send the signal to activate the special effects system 64 to generate the special effects 22 on or near the vessel 18. As such, the special effects system 64 includes one or more sensors 78, one or more light sources 80 (e.g., LEDs, LED strip, multiple LED strips, laser(s), etc.), one or more microphones 82, one or more speakers 84, and/or one or more projectors 86 that may be used to generate special effects 22. The special effects system 64 also includes one or more displays 88, the semi-reflective mirror 24, one or more controllers 92 and/or one or more props 94. As such, the special effects system 64 is used to generate special effects 22 including the illusions (e.g., reflections in the semi-reflective mirror 24) on/or near the vessel 18.

In certain embodiments, one of the controllers 92 of the special effects system 64 may include an audio and visual (A/V) controller. As such, the special effects system 64 may generate A/V effects under control of the controller 92 to provide themed sounds, background effects, projection or the like to enhance guest experiences. The controller 92 may control the light source 80, the microphones 82, the speakers 84, and/or one or more visual output devices (e.g., displays 88, projectors 86, etc.). For example, the controller 92 may control activation of audio recordings, and/or visual displays to enhance the special effects 22 produced by the special effects system 64. As such, the special effects 22 may include audio recordings corresponding to reflections produced in the semi-reflective mirror 24 produced to enhance guest experiences in themed environments. In some instances, the controller 92 may activate a voice associated with a character of the themed environment from speakers 84 positioned near the vessel 18. The special effects 22 surrounding the vessel 18 may appear to an observer as resulting from casting of magical spells (e.g., projected from speaker). Further, likeness of the character may be projected in conjunction to the voice by the controller 92 of the special effects system 64. In some cases, the projector 86 may present various images at various times controlled by special effects system 64, such as to simulate certain movements in conjunction with the special effects 22. As such, the projector 86 may be an external projector, an optical projector with a lens, or the like.

In certain embodiments, the special effects system 64 may cause the one or more displays 88 to display an image towards the semi-reflective mirror 24 to generate the illusion (e.g., the special effects 22) in reflections of the semi-reflective mirror 24 to appear to the observer 14 as occurring on or near the vessel 18. The one or more displays 88 may include a lenticular display (e.g., lenticular volumetric display), a light field display, one or more two-dimensional (2-D) media displays (e.g., 2-D pixel display, light emitting diode (LED) display, organic light emitting diode (OLED) display), one or more projection surfaces (e.g., cylindrical screen, screen), sparse LED displays, and the like. The displays 88 may not be visible to the observer in a viewing area. As such, the displays 88 may be at least partially disposed behind the semi-reflective mirror 24. Further, an area in which the display 88 is located may be sustainably dark (e.g., relative to the viewing area). The display may not be visible to the observer 14 through the semi-reflective mirror 24. The observer 14 may view the image displayed by the display 88 through the semi-reflective mirror 24 while not being aware of the image source.

In certain embodiments, the semi-reflective mirror 24 may include a glass panel with a coating (e.g., layer of metal that may include aluminum and/or silver). The coating may allow the first side of the semi-reflective mirror 24 to be transparent while the second side of the semi-reflective mirror 24 is reflective. As such, the semi-reflective mirror 24 may be at least partially transmissive to visible light. In an embodiment, the coating may be thin (e.g., 100 nm to 30 μm) and the second side of the semi-reflective mirror 24 appears to the observer as a traditional mirror (e.g., fully reflective mirror) while also allowing light transmitted from images on the display 88 to be viewed. In some embodiments, the environment of the first side of the semi-reflective mirror 24 (e.g., the first side includes the display 88) may be significantly darker than the second side of the semi-reflective mirror 24 (e.g., the second side includes the viewing area 50). Wherein “significantly darker” may range from 5 to 10 times less light (e.g., amount of light present) than the viewing area 50. For example, the environment of the second side may be 100-1000 lux, while the environment of the second side may be 0.0001-50 lux when the display 88 is inactive. As such, the display 88 may not be seen by the observer when the special effects system 64 is inactive. Further, the environment of the vessel 18 at a second side of the semi-reflective mirror 24 may be substantially brighter than the environment of a first side of the semi-reflective mirror 24. Wherein “brighter” is defined as having 5 to 10 times more light relative to the first side of the semi-reflective mirror.

With the foregoing in mind, in some embodiments, when the special effects system 64 is activated the image displayed on the display 88 may be observed through the second side of the semi-reflective mirror 24 by the observer. As such, the image displayed on the display 88 may be a portion of the first side of the semi-reflective mirror 24 that may be viewed on the second side of the semi-reflective mirror 24. In this manner, the image displayed on the display 88 may appear to be in a reflection or part of the second side of the semi-reflective mirror 24 generating illusions surrounding the vessel 18 when positioned in the viewing area. In some instances, the special effects system 64 may generate illusions in the reflection of the second side of the semi-reflective mirror 24 in absence of the vessel 18 and/or in absence of activation of the beverage filler system 66.

In some embodiments, the special effects system 64 may include the props 94 that may be actuated to add to illusions generated through the semi-reflective mirror 24 of the show effects system 12. For example, the props 94 may include physical containers (e.g., bottles, glasses, salt and pepper shakers, and the like) that may be included in the viewing area 50 and/or within the environment 10 illustrated in FIG. 1. The props 94 may be controlled by the control system 62 to move (e.g., fall over, change in position) to enhance elements of the show effect system 12. As such, in some instances, the props 94 may include a bottle in which a food or beverage preparer appears to pick up. The bottle may be actuated using electric motors, servos, robot arms, mechanical linkages such as solenoids, and the like. In one case, the food or beverage preparer may appear to knock over the bottle during illusions generated by the special effects system 64. As such, use of the props 94 (e.g., physical items) may add to the immersive guest experience.

The control system 62 of FIG. 2 may send the signal to activate beverage filler system 66 to fill the vessel 18 from a fluid source 96. The fluid source 96 may include a beverage (e.g., beer, mixed drink, juice, alcoholic beverage, non-alcoholic beverage, soda, water, etc.) ordered by the observer. It should be noted, that the fluid source 96 may include a non-beverage fluid such as condiments, cheese, gravy, syrup, and the like. The beverage filler system 66 may include one or more sensors 98, a controller 100, a valve 102, and the base 20 used to provide liquid to the vessel 18 in conjunction with visual effects generated using the special effects system 64. For example, the control system 62 may activate the beverage filler system 66 upon receiving a signal indicative of a presence of the vessel 18 on the base 20. As such the controller 100 (e.g., a beverage controller) may activate a flow of beverage into the vessel 18. The beverage flows through the valve 102 disposed on an end of the vessel 18 positioned on the base 20. In some instances, the flow of beverage may be pressurized.

In some embodiments, the beverage controller 100 may activate and/or deactivate the flow of beverage into the vessel 18 through actuation of the valve 102 based on data from the one or more sensors 98. The sensors 98 may include flow meters (e.g., electromagnetic flowmeter, turbine flow meter, ultrasonic flow meter, and/or displacement flowmeter) that may monitor the flow of beverage from the fluid source 96. Additionally, in some embodiments, the sensors 98 may monitor the base 20 to determine a presence of the vessel 18. As such, the sensors 98 may include hall effect sensors, cameras, magnetic sensors, pneumatic sensors, electromechanical sensors, and the like. The presence of the vessel 18 on the base 20 may activate the flow of beverage. In some instances, an absence of the vessel 18 on the base 20 may deactivate the flow of beverage into the vessel 18.

In some embodiments, the vessel 18 may include the valve 102. The valve 102 may include a first configuration in which the valve 102 of the vessel 18 is closed and sealed. When the valve 102 of the vessel 18 is sealed, the flow of the beverage is not activated. In certain embodiments, the valve 102 may include a second configuration or an open configuration in which the vessel 18 is positioned on the base 20 allowing the flow of the beverage into the vessel 18 through the valve 102. When the valve 102 is open, the flow of the beverage from the fluid source 96 may fill the vessel 18 with the beverage. The valve 102 may be a mechanical valve that is opened based on a mechanical interaction with the base 20. In an embodiment, the valve 102 may be controlled by the beverage controller 100 to actuate into the second configuration based on sensor data detected by the sensors 98. In some instances, the sensors 98 may include a hall effect sensor. As such, the valve 102 disposed on the vessel 18 may be magnetic. The hall effect sensor may sense the presence of the vessel 18 based on a presence of the valve 102 (e.g., magnetic valve). Further, the hall effect sensor may transduce a signal based on the presence of the vessel 18 on the base 20 (e.g., magnetic detected by the hall sensor) to the beverage controller 100 in order to activate the flow of beverage into the vessel 18. In should be noted, that in some embodiments, the presence of the vessel 18 as determined by the sensor data may activate the special effects system 64 in addition to or without activation of the beverage filler system 66.

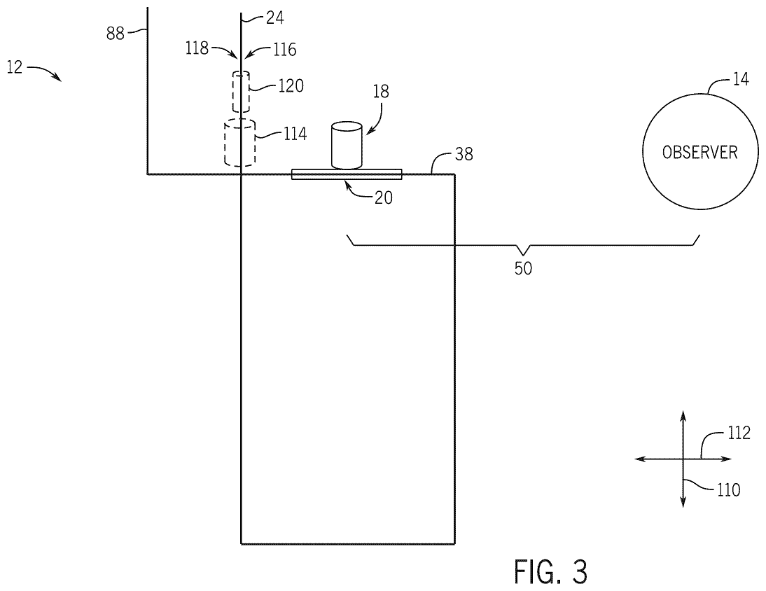

FIG. 3-5 are examples of arrangements of the show effects system 12 or individual components thereof. It should be understood that the disclosed embodiments may include all or some of the disclosed the show effects system 12 of FIG. 2.

FIG. 3 is a schematic illustration of a side view of the show effects system 12. In certain embodiments, the show effects system 12 may include the vessel 18 supported by the base 20 positioned on the surface 38 (e.g., bar). To aid the discussion, a set of axes will be referenced. For example, a longitudinal axis 110 may run from the top of the display 88 to the surface 38 while a latitudinal axis 112 may run from the display 88 to the observer 14. In some embodiments, when the vessel 18 is positioned on the base 20 a reflection 114 of the vessel 18 is formed in the semi-reflective mirror 24. The reflection 114 of the vessel 18 may be formed on a second side 116 of the semi-reflective mirror 24. The second side 116 of the semi-reflective mirror 24 may be observed by the observer 14. The second side 116 of the semi-reflective mirror 24 displays a reflection of an environment of the vessel (e.g., reflection of the viewing area 50) including the reflection 114 of the vessel 18 when the vessel 18 is positioned within the viewing area 50. As such, in some instances, when the special effects system 64 is not activated the observer 14 may still view the reflection of the environment of the vessel 18 and/or the reflection 114 of the vessel 18 on the second side 116 of the semi-reflective mirror 24. In this manner, the semi-reflective mirror may appear to the observer 14 as a traditional reflective mirror (e.g., non-transparent mirror).

In some embodiments, the display 88 positioned on a first side 118 of the semi-reflective mirror 24 may display images that appear as an illusion 120 viewable by the observer 14 in the semi-reflective mirror 24. As such, the illusion 120 may appear to be above, below, within, or otherwise overlaid in relation to the reflection of the environment of the vessel 18 and/or the reflection 114 of the vessel 18. For example, the display 88 may display images that are transmitted through the first side 118 and visible on the second side 116 to generate the illusion 120 in the semi-reflective mirror 24 through manipulation of lighting between the first side 118 and second side 116 of the semi-reflective mirror 24. As such, the first side 118 of the semi-reflective mirror 24 may be sustainably dark. That is, the first side 118 of the semi-reflective mirror 24 may be darker (e.g., 5 to 8 times darker) than the second side 116 of the semi-reflective mirror. The display (e.g., when not displaying an image) may not be visible to the observer 14 through the semi-reflective mirror 24. Further, light on the second side 116 of the semi-reflective mirror 24 (e.g., within the viewing area 50) masks transmission of the first side 118 making the semi-reflective mirror 24 appear as reflective. In an embodiment, the first side 118 has an antireflective coating while the second side 116 has an at least partially transmitting coating that is reflective.

In certain embodiments, when the image is displayed by the display 88 the observer 14 may view the image through the semi-reflective mirror 24 while not being aware of the image source. As such, the image generates the illusion 120 that may be viewed on the second side 116 of the semi-reflective mirror 24 by the observer 14. For example, the image produced by the display 88 is bright and therefore transmitted through the semi-reflective mirror 24 and viewed by the observer 14. Wherein “bright” is defined as similar (e.g., within 10 to 20 percent) to the brightness of the viewing area 50 (e.g., second side 116 of the semi-reflective mirror 24). The display 88 may generate various images that include a food or beverage preparer, special effects of beverages being poured into the vessel 18, or any additional illusions 120 that may add to the immersive experience of the observer 14.

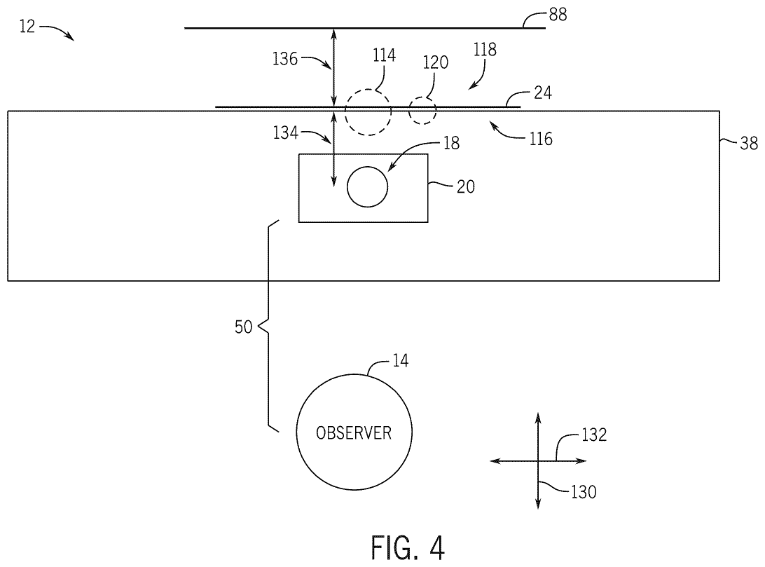

FIG. 4 is a schematic illustration of a top view of the show effects system 12. In certain embodiments, the special effects system 64 and the beverage filler system 66 of the show effects system 12 may be aligned to create realistic illusions and special effects through reflections in the semi-reflective mirror 24. To aid the discussion, a set of axes will be referenced. For example, a longitudinal axis 130 may run from the observer 14 to the display 88 while a latitudinal axis 132 may along the surface 38 parallel to the semi-reflective mirror 24. In certain embodiments, the show effects system 12 includes the vessel 18 supported by the base 20 positioned on the surface 38. As such, the vessel 18 on the second side 116 of the semi-reflective mirror 24 may be positioned a first distance 134 equal to a second distance 136 between the semi-reflective mirror 24 and the display 88.

In certain embodiments, the first distance 134 and the second distance 136 are of equal length. As such, the illusion 120 generated by the image projected by the display 88 may be perceived by the observer 14 as appearing at a proper depth to appear as if the illusion 120 is impacting the environment of the vessel 18 in front of the semi-reflective mirror 24. The reflection 114 of the vessel 18 and the illusion 120 may be formed at the proper depth along the latitudinal axis 132 along the semi-reflective mirror 24. In some instances, the reflection 114 of the vessel 18 and the illusion 120 may overlap with one another. For example, the illusion 120 may appear as a colored liquid (e.g., a potion, a magical concoction) overlaid on the reflection 114 of the vessel 18. As such, the illusion 120 may appear to the observer 14 within the same plane of the reflection 114 of the vessel 18 when viewed from the second side 116 of the semi-reflective mirror 24. Additionally or alternatively, in some embodiments, the illusion 120 may appear to surround (e.g., appearing above, below, next to, and the like) the reflection 114 of the vessel 18. The illusion 120 may be an arm (e.g., the arm of the food or beverage preparer 26) and may create the illusion 120 of pouring the beverage into the vessel 18 out of thin-air (e.g., in absence of a staff member).

In some embodiments, it may be advantageous for the first distance 134 and the second distance 136 to not be equivalent. As such, the second distance 136 may be shorter or longer than the first distance 134. The illusion 120 may be generated to appear as occurring behind and/or in front of the reflection 114 of the vessel 18. For example, the second distance 136 may be shorter than the first distance 134 allowing for the illusion 120 to appear behind the vessel 18. The illusion 120 may be a monster that may appear to be positioned (e.g., floating, standing) behind the reflection 114 of the vessel 18. Differences in the first distance 134 and the second distance 136 may add realistic depth perception when the special effects system 64 is activated by the control system 62 of the show effects system 12.

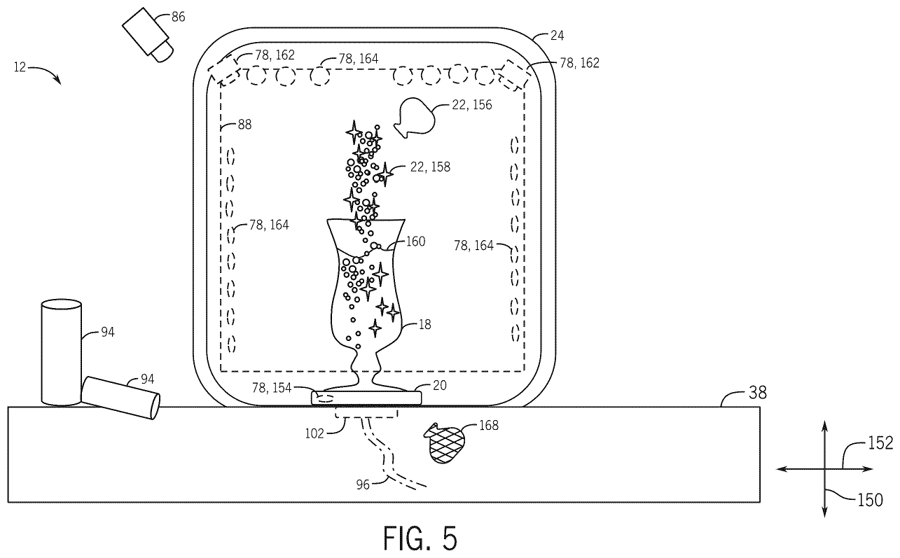

FIG. 5 is a schematic illustration of the vessel 18 interacting with the show effects system 12. In certain embodiments, the generation of the special effects 22 may be achieved through reflections in the semi-reflective mirror 24. To aid the discussion, a set of axes will be referenced. A longitudinal axis 150 may run from the top of the display 88 to the surface 38 while a latitudinal axis 152 may run along the surface 38 parallel to the semi-reflective mirror 24.

In some embodiments, the vessel 18 may be supported by the base 20 located on the surface 38 (e.g., bar). The base 20 may be coupled with the valve 102 that controls the flow of beverage from the fluid source 96. The base 20 may include the sensor 78, 154. In some instances, the sensor 78, 154 may be used to detect the presence of the vessel 18 on the base 20. For example, the beverage controller 100 may send a signal to the control system 62 that the sensor 78, 154 detected the presence of the vessel 18 on the base 20. As such, the control system 62 may activate the special effects system 64 to activate the special effects 22. The special effects 22 may include illusions of the food or beverage preparer 26 pouring a potion 22, 156 into the vessel 18 displayed as reflections in the semi-reflective mirror 24. The potion 22, 156 may appear to generate a flow of liquid 22, 158 (e.g., bubbles, colored liquid, slime, fantastic liquid, or the like) into the vessel 18. The potion 22, 156 and the flow of liquid 22, 158 is generated by the display 88 positioned behind the semi-reflective mirror 24.

In certain embodiments, the control system 62 may activate the beverage filler system 66 to fill the vessel 18 with the beverage as the special effects 22 are generated on or near the vessel 18. The beverage filler system 66 may be controlled to fill the vessel 18 to a fill level 160 during generation of illusions by the display 88 into the semi-reflective mirror 24. The fill level 160 may correspond to the special effects 22 overlaid on the reflection of the vessel 18 in the semi-reflective mirror. For example, the special effects 22 may include a character appearing to be sitting in the vessel 18 before activation of the beverage filler system 66. Upon activation of the beverage filler system 66 the character may appear to float (e.g., dynamically change position) matching the fill level 160 of the vessel 18 as the flow of the beverage (e.g., physical liquid from the fluid source 96). Further, the special effects system 64 may stop displaying on the one or more displays 88 based on the fill level 160 of the vessel 18. The beverage filler system 66 may be used to signal that the special effects 22 may be completed and the observer 14 may be provided the vessel 18 by the staff member 16. The dynamic interaction of the special effects system 64 with the beverage filler system 66 may add to the immersive experience of the observer 14.

In some embodiments, the one or more sensors 78 of the special effects system 64 may be positioned on the display 88 behind the semi-reflective mirror 24. The sensors 78 may include cameras 78, 162 and/or additional sensors 78, 164. The cameras 78, 162 and/or the additional sensors 78, 164 may be used by the show effects system 12 to enhance the immersive experience. For example, the cameras 78, 162 may detect a presence of the observer 14 within a viewing area and track movement of an observer. The cameras 78, 162 may be skeletal tracking cameras, depth cameras, infrared cameras, and/or the like. As such, the cameras 78, 162 may monitor facial movements of the observer and provide the control system 62 with a signal. In some cases, the signal may be used by the control system 62 to instruct the special effects system 64 to generate dynamic and/or interactive images on the display of the a food or beverage preparer. The food or beverage preparer special effects 22 may be personalized to the observer. In an embodiment, the food or beverage preparer may appear to make eye contact with the observer. Further, the food or beverage preparer may be manipulated in real time to produce effects and/or interactions with guests. Manipulation of the special effects 22 may be achieved through real time game engineering of the image and/or by using machine learning models to monitor observer interactions and provide dynamic interactions that may correlate with expected character interactions.

With the foregoing in mind, in certain embodiments, the special effects 22 may be synchronized with physical effects to enhance the illusions generated in reflections of the semi-reflective mirror 24. Props 94 may be actuated by the special effect system 64 to add to the immersive experience. For example, in the illustrated embodiment, the props 94 may represent a salt shaker and a pepper shaker on the surface 38 (e.g., bar). The salt shaker and the pepper shaker may appear to be knocked over when the special effect 22 is displayed in the semi-reflective mirror 24 (e.g., reflections in the semi-reflective mirror 24). As such, the props 94 may actuate through implementation of motors, solenoids, robotic arms or the like controlled by the controller 92 of the special effects system 64. The observer may view movement of the props 94 that appear to result from a food or beverage preparer casting a spell. In some instances, the props 94 may be actuated before, after, during or at any suitable point in time to enhance the illusions on or near the vessel 18.

In some embodiments, the show effects system 12 may activate the show effects system 12 to generate projections on the surface 38 (e.g., bar). Synchronized visual effects may be created to accompany the illusions appearing as reflections in the semi-reflective mirror 24. Projections of a shadow 168 may be generated within the viewing area 50 corresponding to the illusion in the semi-reflective mirror 24. For example, the shadow 168 of the potion 22, 156 and the flow of liquid 22, 158 may be projected by the projector 86 of the special effects system 64 on to the bar. The shadow 168 may enhance the special effects 22, 156 and generate dark shadows of the potion 22, 156 corresponding to the illusion. In some instances, the arm of the food or beverage preparer may appear as a shadow on the surface 38 to suggest to the observer that the food or beverage preparer 26 is present between the semi-reflective mirror 24 and the vessel 18 within the viewing area 50. In some embodiments, the projector 86 may be located at least partially out of view of the observer.

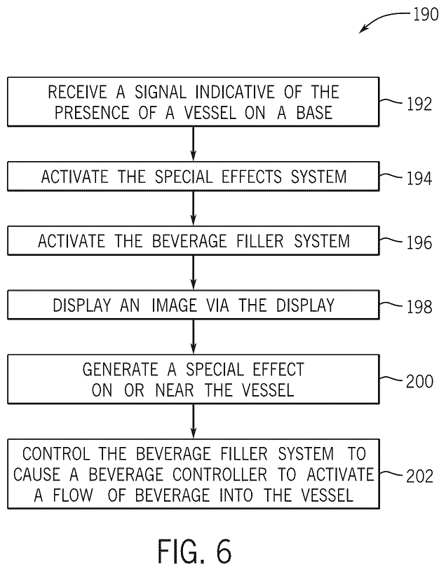

FIG. 6 is a process flow diagram illustrating an embodiment of a method 190 of operating the show effects system 12. The method 190 may include at block 192 the control system 62 receiving a signal indicative of the presence of the vessel 18 within the viewing area 50 of the special effects system 64. At block 194, the special effects system 64 may be activated to generate the special effect 22 based on the signal. At block 196, the beverage filler system 66 may be activated. At block 198, the special effects system 64 may display the image on the display 88. Further, at block 200 the special effects system 64 generates the special effects 22 on or near the vessel 18. The special effects 22 may be generated reflections viewable by the observer 14 in the semi-reflective mirror 24. At block 202, the control system 62 may control the beverage filler system 66 to activate the beverage controller 100 to activate the flow of beverage into the vessel 18. In some cases, the flow of beverage may be generated from the fluid source 96 through the valve 102 when the vessel 18 is supported by the base 20. In some embodiments, the control system 62 may activate the special effects system 64 and the beverage filler system 66 simultaneously to create illusions and prepare orders of the observer 14. As such, the special effects 22 may create illusions through reflections within the semi-reflective mirror 24 while the vessel 18 is filled with the beverage in order to enhance guests experiences in the food and beverage venue. It should be noted, that the control system 62 may control the special effects system 64 to activate in the presence of or in the absence of the vessel 18. Further, the control system 62 may activate the beverage filler system 66 at any suitable time such as before, after, or in absence of the activation of the special effects system 64.

While only certain features of the disclosed technology have been illustrated and described herein, many modifications and changes will occur to those skilled in the art. It is, therefore, to be understood that the appended claims are intended to cover all such modifications and changes as fall within the true spirit of the disclosure. Furthermore, although the steps of the disclosed flowchart/s are shown in a given order, in certain embodiments, the depicted steps may be reordered, altered, deleted, and/or occur simultaneously.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A show effects system, comprising:
a beverage filler system comprising:
a base configured to support a vessel;
a beverage controller configured to control a flow of a beverage into the vessel;
a special effects system comprising:
one or more displays configured to display an image;
a semi-reflective mirror comprising a first side and a second side and positioned between the one or more displays and the vessel, wherein the semi-reflective mirror is configured to permit viewing of the image on the display, transmitted through the first side, at the second side and viewing of a reflection of an environment of the vessel at the second side; and
a control system, wherein the control system comprises:
a processor configured to:
receive a signal indicative of a presence of the vessel on the base; and
activate at least the special effects system or the beverage filler system based on the signal, wherein activating the special effects system causes the one or more displays to display the image and wherein activating the beverage filler system causes the beverage controller to activate the flow of beverage into the vessel.

2. The show effects system of claim 1, wherein the vessel comprises a valve having a first configuration in which the valve of the vessel is sealed and a second configuration in which the vessel is positioned to allow flow of a beverage into the vessel through the valve.

3. The show effects system of claim 1, wherein the beverage filler system may include one or more bases.

4. The show effects system of claim 1, wherein the first side of the semi-reflective mirror comprises an antireflective coating.

5. The show effects system of claim 4, wherein the environment of the vessel at the second side of the semi-reflective mirror is substantially brighter than an environment of the first side of the semi-reflective mirror.

6. The show effects system of claim 1, wherein the special effects system includes one or more props configured to be actuated.

7. The show effects system of claim 1, wherein the second side of the semi-reflective mirror is at least partially transmissive to visible light.

8. The show effects system of claim 1, wherein the image displayed by the one or more displays is prerecorded.

9. The show effects system of claim 1, wherein the special effects system comprises one or more sensors.

10. The show effects system of claim 9, wherein the one or more sensors are configured to monitor a presence of an observer.

11. A method comprising:
receiving a signal indicative of a presence of a vessel on a base;
activating, via a control system, at least a special effects system or a beverage filler system based on the signal;
displaying an image, via one or more displays;
generating a special effect on or near the vessel; and
controlling the beverage filler system to cause a beverage controller to activate a flow of beverage into the vessel from the base.

12. The method of claim 11, comprising:
monitoring, via the beverage filler system, the flow of the beverage into the vessel; and
determining, via the control system, a fill level of the vessel based on sensor data.

13. The method of claim 12, comprising:
receiving a signal indicative of the fill level of the vessel; and
controlling, via the special effects system, the image to stop displaying on the one or more displays.

14. The method of claim 11, comprising:
receiving a signal indicative of generation of the special effect; and
actuating one or more props; wherein the one or more props is configured to move with a viewing area.

15. The method of claim 11, wherein the special effect comprises an illusion visible on a semi-reflective mirror.

16. A show effects system, comprising:
a special effects system comprising:
a controller;
one or more displays configured to display an image;
a semi-reflective mirror comprising a first side and a second side and positioned between the one or more displays and a vessel, wherein the semi-reflective mirror is configured to permit viewing of the image on the display, transmitted through the first side, at the second side and viewing of a reflection of an environment of the vessel at the second side;
one or more props configured to actuate; and
a control system, wherein the control system comprises:
a processor configured to:
receive a signal indicative of a presence of the vessel on a base;
activate the special effects system based on the signal, wherein activating the special effects system comprises causes the one or more displays to display the image and the one or more props to actuate; and
activate a beverage filler system wherein activating the beverage filler system causes a beverage controller to activate a flow of beverage into the vessel.

17. The show effects system of claim 16, wherein the beverage filler system is configured to flow the beverage into the vessel from a bottom of the vessel through a valve of the vessel.

18. The show effects system of claim 16, wherein the environment of the vessel at the second side of the semi-reflective mirror is substantially brighter than an environment of the first side of the semi-reflective mirror.

19. The show effects system of claim 16, wherein the signal indicative of a presence of the vessel on a base is based on sensor data.

20. The show effects system of claim 19, wherein the special effects system comprises one or more sensors configured to sense at least a presence or an absence of the vessel on the base and generate the sensor data.
